(19) United States
(12) Patent Application Publication
(10) Pub. No.: US 2006/0169014 A1
(43) Pub. Date: Aug. 3, 2006

(54) Composition for the nutrition and irrigation of plants

(75) Inventor: Manuel Mata Brenuy, L'Hospitalet De Llobregat (ES)

Correspondence Address: YOUNG & THOMPSON, 745 SOUTH 23RD STREET, 2ND FLOOR, ARLINGTON, VA, 22202, US

(73) Assignee: LABORATORIOS DIET-ESTHETIC, S.A., L'HOSPITALET DE LLOBREGAT (ES)

(21) Appl. No.: 11/334,353

(22) Filed: Jan. 19, 2006

(30) Foreign Application Priority Data
Jan. 31, 2005 (ES) 200500173
Jan. 6, 2006 (ES) 200600016

(51) Int. Cl. C05F 11/02

(52) U.S. Cl. 71/24

(57) ABSTRACT

Composition for the nutrition and irrigation of plants includes water, cellulose, potassium nitrate and at least one of foliar fertilizers, salinity correctors, biostimulants, humic acids and fulvic acids.

### OBJECT OF THE INVENTION

The object of the present invention such as it is expressed in the announcement of this descriptive memory refers to some improvement in the composition for the nutrition and the irrigation of plants on the basis of water and nutrients served in a gelatinous form, in a way that said composition is the base of the obtention of a variety of specific products for the care of the plants, using as a support base the composition revindicated in the patent principle P200500173, by means of a partial or total substitution of the potassium nitrate of its composition.

This range of obtained products aims to the care of plants by means of the incorporation of foliar fertilizers, salinity correctors, bio-stimulants and humic and fluvic acids which will be administered in the form of a gel in a sustained form during a long period of time only with one sole application of the product.

### ANTECEDENTS OF THE INVENTION

In the principle patent P200500173, a composition of water, cellulose and nutrients in a slow release gelatinous form is revindicated which gradually converts into liquid on coming into contact with the microbiological activity natural to soil, which supposes a new concept in the irrigation of plants: a 100% natural product which permits the plants to stay in a perfect state for 30 days or more (depending on the dosage supplied) without the need to water or fertilize them. The water, nutrients and the selfsame cellulose which are released in a gradual and constant manner are 100% usable by the roots of the plant, the water dissolving the nutrients belonging to the soil of the plant-pot, and the cellulose together with the potassium nitrate acting as complementary nutrients of reinforcement.

Specifically, the innovative composition for the nutrition and the irrigation of plants is made up of three elements, water in 94 to 98% of its weight, cellulose in 3.5 to 4% of its weight and potassium nitrate in 0.4 to 3.5% of its weight.

In this composition, the molecules of water and potassium nitrate are mechanically linked with the cellulose molecule. This composition at atmospheric temperature has a gelatinous consistency, being packaged for its use in a container of plastic material with a lid.

### DETAILED DISCRIPITION OF THE INVENTION

Specifically, the improvements introduced in the objective of the principle patent P200500173 consist of the total or partial substitution of potassium nitrate present in a percentage of the of between 0.4 and 3.5% in the composition revicated in the principle patent, by a different element capable of mechanically linking the cellulose molecule so as to be systematically released conforming to the microbiological activity which destroy the chemical links. These elements are organized into four groups according to their function:

Folic fertilizer group, made up of different mixtures of Nitrogen, phosphoric oxide, potassium oxide, Magnesium oxide, boron, zinc, Magnesium, molybdenum, iron, more micronutrients added in a proportion in all cases not superior to 0.5%. These ingredients may have been complexed by EDTA, DTPA, EDDHA, boric and heptagluconic acid. They may be supplied by different types of clays rich in all or part of the minerals described. These folic fertilizers have as a function the contribution of the natural plant minerals; they are applicable for foliar or fertilizer irrigation.

Corrector of salinity group, made up of calcium oxide complexed by lignosulfonics and heptagulconate acid in a percentage in weight of between 0.4% and 3.5% of the total. This salinity corrector has the function of supplementing the lack of calcium.

Bio stimulant group made up of phosphates of potassium equivalent to 60% of the phosphoric acid, or a mixture of protein nitrogen plus free amino acids plus oligopeptides plus polypeptides proceeding from controlled hydrolysis without chloride. These elements are incorporated in the composition in a proportion of between 0.4% to 3.5% in weight and have the function of stimulating the natural defences of the plants against fungi. Systematic by foliar means, establishing itself and absorbed even by the skin or bark.

Humic and fulvic acid group (HUMUS), constituted by complex organic molecules which are formed by the break down of the organic material by means of the action of the micro organisms in the soil and the earth worms. Preferably, the source of this humus will be the layer of deposits in Montana and Dakota (USA) being previously treated to sulfurized to modify their physical chemical properties to use for foliar or fertilizer irrigation. The incorporation of these humic and fulvic acids in the general composition in a percentage of between 0.4% to 3.5% in weight.

In this way a final composition has been obtained, made up of water in 94% to 96:2% of the weight, cellulose in 3.5% to 4% of the weight, and a complementary composition in proportion of between 0.4% and 3.5% in weight of the composition, which at the same time is constituted of 0% to 95% of potassium nitrate and 5% to 100% of any of the elements described in the aforementioned four anterior groups or a combination of two or more of these.

Having established the expressed concept, there now follows the edition of the revindications, in synthesis the innovations that are to be revindicated are as follows:

1. Improvements introduced in the object of the patent principle P200500173 for Composition for the nutrition and irrigation of plants”, referent to a composition of 94 to 96.6% of weight of water, 3.5 to 4% in weight of cellulose and 0.4 to 3.5% in weight of potassium nitrate, these improvements are characterized by the incorporation of foliar fertilizers or salinity correctors or biostimulantes or humic and fulvic acids in partial or total substitution of potassium nitrate.

2. Improvements introduced in the object of the patent principle P200500173 for: “Composition for the nutrition and irrigation of plants” according to claim 1, characterized because the foliar fertilizers are made up of different mixtures of Nitrogen, phosphous oxide potassium oxide, Magnesium oxide, Boron, Zinc, Magnesium, Molibdeno, Iron, plus chelated micronutrients in a proportion in all cases of not more than 0.5% of the weight of the composition.

3. Improvements introduced in the object of the patent principle P200500173 for the: “Composition for the nutrition and irrigation of plants” according to claim 2 characterized because the foliar fertilizers may have been chelated by EDTA, DTPA, EDDHA, boron and heptagulconic acid.

4. Improvements introduced in the object of the patent principle P200500173 for: “Composition for the nutrition and irrigation of plants” according to claim 2 characterized because the folic fertilizers are provided by different types of clays rich in all or part of the minerals described in revindication 2.

5. Improvements introduced in the object of the patent principle P200500173 for “Composition for the nutrition and the irrigation of plants” according to claim 1, characterized because the corrector of salinity is preferably Calcium oxide complexed by lignosulfonics and heptagulconic acid in a percentage in weight of between 0.4% and 3.5% in total.

6. Improvement in the object of the principle patent P200500173 for: “Composition for the nutrition and irrigation of plants” according to claim 1, characterized because the bio stimulants, are constituted of potassium phosphates equivalent to 60% of the phosphoric acid, or a mixture protein nitrogen plus free amino acids oligopeptides plus polypeptides proceeding from controlled hydrolysis without chloride, incorporating these elements into the composition in a proportion of between 0.4% and 3.5% in weight.

7. Improvement introduced in the object of the principle patent P200500173 for: “Composition for the nutrition and irrigation of plants” according to claim 1, characterized because the humic and fulvic acids are preferably made up of layer deposits from Montana and Dakota (USA) being previously sulfurized to modify their physical chemical properties to use for the fulvic or fertilizer irrigation, the incorporation of these acids in the general composition in a proportion of between 0.4% and 3.5% in weight.
